(19) United States
(12) Patent Application Publication
(10) Pub. No.: US 2025/0031081 A1
(43) Pub. Date: Jan. 23, 2025

(54) APPARATUS AND METHOD FOR TRACING OPEN RADIO ACCESS NETWORK (O-RAN) INTERFACES

(71) Applicant: CommScope Technologies LLC, Claremont, NC (US)

(72) Inventor: Shailendra Yadav, Gurgaon (IN)

(73) Assignee: CommScope Technologies LLC, Claremont, NC (US)

(21) Appl. No.: 18/716,478

(22) PCT Filed: Feb. 15, 2023
(86) PCT No.: PCT/US2023/062651

§ 371 Date: Jun. 4, 2024

(30) Foreign Application Priority Data
Feb. 15, 2022 (IN) 202211007998

(51) Int. Cl. H04W 24/10; H04W 24/08; H04W 92/18

(52) U.S. Cl. CPC H04W 24/10; H04W 24/08; H04W 92/18

(57) ABSTRACT

The present disclosure describes methods and apparatus for tracing open radio access network (O-RAN) operations. The tracing technique includes tracing O-RAN operations. based on a plurality of tracing parameters. by capturing communication with at least one of a plurality of RAN Intelligent Controller (RIC) components controlling the O-RAN operations over a plurality of interfaces. Further, the tracing technique includes generating a report comprising trace data based on the tracing in a predefined format.

### CROSS-REFERENCE TO RELATED APPLICATIONS

This application claims priority to IN Provisional Application No. 202211007998 filed on Feb. 15, 2022, and titled “AN APPARATUS AND METHOD FOR TRACING OPEN RADIO ACCESS NETWORK (O-RAN) INTERFACES,” the contents of which are hereby incorporated by reference in their entirety.

### TECHNICAL FIELD

The present disclosure in general relates to wireless communication. More particularly, but not exclusively, to techniques for tracing interfaces defined by the O-RAN Alliance (where the acronym “O-RAN” refers to “Open-Radio Access Network”).

### BACKGROUND

The O-RAN Alliance promulgates specifications related to implementing radio access networks (RAN) in an open and interoperable manner. Hereinafter, references to “O-RAN” refer to the O-RAN Alliance. In general, the O-RAN specifications are built upon, and are complementary to, the associated 3rd Generation Partnership Project (3GPP) specifications for Fifth Generation (5G) New Radio (NR) and Fourth Generation (4G) Long Term Evolution (LTE) cellular technology.

The 3GPP standards define various trace management services that can be used to trace activity at the cell level or user equipment (UE) level. However, such 3GPP tracing is defined in the context of the 3GGP architecture and not the O-RAN architecture. As a result, 3GPP tracing is not defined for interfaces defined by O-RAN but is for 3GPP. One consequence of this is that 3GPP tracing does not address interfaces related to RAN Intelligent Controller (RIC) functions defined by O-RAN.

The information disclosed in this background section is only for enhancement of understanding of the general background of the disclosure and should not be taken as an acknowledgement or any form of suggestion that this information forms the prior art already known to a person skilled in the art.

### SUMMARY

One or more shortcomings discussed above are overcome, and additional advantages are provided by the present disclosure. Additional features and advantages are realized through the techniques of the present disclosure. Other embodiments and aspects of the disclosure are described in detail herein and are considered a part of the disclosure.

An objective of the present disclosure is to implement tracing techniques for overseeing performance of open radio access network (O-RAN) operations.

Yet another object of the present disclosure is to provide a holistic view of the functioning of a network in a single glance to an operator by implementing the tracing technique.

The above stated objects as well as other objects, features, and advantages of the present disclosure will become clear to those skilled in the art upon review of the following description, the attached drawings, and the appended embodiments.

According to an aspect of the present disclosure, methods and apparatus are provided for tracing open radio access network (O-RAN) interfaces.

In one non-limiting embodiment of the present disclosure, a method includes tracing open radio access network (O-RAN) operations, based on a plurality of tracing parameters, by capturing communication with at least one of a plurality of RAN Intelligent Controller (RIC) components controlling the O-RAN operations over a plurality of interfaces. Further, the method comprises generating a report comprising trace data based on the tracing in a predefined format.

In another non-limiting embodiment of the present disclosure, the method further comprising receiving a trace activation request from a device associated with an entity intended to trace O-RAN operations. The trace activation request comprises the plurality of tracing parameters.

In another non-limiting embodiment of the present disclosure, the predefined format comprises a file-based format or a streaming format.

In another non-limiting embodiment of the present disclosure, the method further comprises transmitting the report to the device associated with the entity, wherein the entity comprises an operator providing services to subscribers.

In another non-limiting embodiment of the present disclosure, the plurality of RIC components comprises a non-real time RIC (Non-RT RIC) and a near-real time RIC (Near-RT RIC). The communication with the at least one RIC component comprises a communication between the at least one RIC component and an E2 node. The E2 node is used to implement a base station to provide wireless service to a plurality of user equipment using the cells. The E2 node comprises at least one of an eNodeB (eNB), an O-RAN Central Unit-Control Plane (O-CU-CP), an O-RAN Central Unit-User Plane (O-CU-UP), an O-RAN Distributed Unit (O-DU), and a Next Generation NodeB (gNB). The plurality of interfaces comprises an A1 interface and an E2 interface, wherein the A1 interface facilitates communication between the Non-RT RIC and the Near-RT RIC, and the E2 interface facilitates communication between the Near-RT RIC and the E2 node.

In another non-limiting embodiment of the present disclosure, the method of tracing the O-RAN operations further comprises capturing communication between the E2 node and at least one of the plurality of user equipment.

In another non-limiting embodiment of the present disclosure, the plurality of tracing parameters comprises at least one of a RIC ID, an E2 Node ID, a Near-RT RIC Trace ID, a Trace Depth, a list of Near-RT RIC interfaces, and an IP address of the device. The RIC ID comprises a unique identifier of a RIC controlling the O-RAN operations. The E2 Node ID comprises a unique identifier of a E2 node associated with the RIC. The Near-RT RIC Trace ID comprises a unique identifier of a Near-RT RIC associated with the RIC. The Trace Depth comprising a set of trace levels indicating a degree of information to be traced while tracing the O-RAN operations, wherein the set of trace levels comprises a minimum trace, a medium trace, and a maximum trace. The list of Near-RT RIC interfaces comprises a list of interfaces over which the plurality of RIC component communicates.

In another non-limiting embodiment of the present disclosure, an apparatus comprises a memory, at least one transceiver, and at least one processor communicatively coupled with the memory and the at least one transceiver. The at least one processor is configured to trace open radio access network (O-RAN) operations, based on a plurality of tracing parameters, by capturing communication with at least one of a plurality of RAN Intelligent Controller (RIC) components controlling the O-RAN operations over a plurality of interfaces. The at least one processor is further configured to generate a report comprising trace data based on the tracing in a predefined format.

In another non-limiting embodiment, the at least one processor is further configured to receive a trace activation request from a device associated with an entity intended to trace O-RAN operations. The trace activation request comprises the plurality of tracing parameters.

In another non-limiting embodiment of the present disclosure, a non-transitory computer readable media stores one or more instructions executable by at least one processor, the one or more instructions comprises one or more instructions for tracing open radio access network (O-RAN) operations, based on a plurality of tracing parameters, by capturing communication with at least one of a plurality of RAN Intelligent Controller (RIC) components controlling the O-RAN operations over a plurality of interfaces. The one or more instructions further comprise one or more instructions for generating a report comprising trace data based on the tracing in a predefined format.

In another non-limiting embodiment, the one or more instructions further comprise one or more instructions for receiving a trace activation request from a device associated with an entity intended to trace O-RAN operations. The trace activation request comprises the plurality of tracing parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Further aspects and advantages of the present disclosure will be readily understood from the following detailed description with reference to the accompanying drawings. Reference numerals have been used to refer to identical or functionally similar elements. The figures together with a detailed description below, are incorporated in and form part of the specification, and serve to further illustrate the embodiments and explain various principles and advantages, in accordance with the present disclosure wherein:

FIG. 1 shows an exemplary environment 100 illustrating tracing of O-RAN operations, in accordance with some embodiments of the present disclosure.

FIG. 2 shows a detailed block diagram 200 illustrating an apparatus, in accordance with some embodiments of the present disclosure.

FIG. 3 shows a trace start operation 300, in accordance with some embodiments of the present disclosure.

FIG. 4 shows a trace stop operation 400, in accordance with some embodiments of the present disclosure.

FIG. 5 shows a trace operation at an E2 interface 500, in accordance with some embodiments of the present disclosure.

FIG. 6 shows a trace operation at an A1 interface 600, in accordance with some embodiments of the present disclosure.

FIG. 7 shows a trace operation at A1 and E2 interfaces 700, in accordance with some embodiments of the present disclosure.

FIG. 8 shows a flowchart of a method 800 for tracing O-RAN operations, in accordance with some embodiments of the present disclosure.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present disclosure described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s),” “comprising,” “include(s),” or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus preceded by “comprises . . . a” does not, without more constraints, preclude the existence of other elements or additional elements in the system.

The terms like “at least one” and “one or more” may be used interchangeably throughout the description. The terms like “a plurality of” and “multiple” may be used interchangeably throughout the description. The terms like “RAN Intelligent Controller” and “RIC” may be used interchangeably throughout the description. The terms like “open radio access network” and “O-RAN” may be used interchangeably throughout the description. The terms like “entity” and “trace collection entity” and “operator” may be used interchangeably throughout the description.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

RAN intelligent controller (RIC) functions are essential components of the O-RAN architecture and, generally, are responsible for controlling and optimizing O-RAN operations. Typically, the RIC functions comprise a non-real time RIC (Non-RT RIC) and a near-real time RIC (Near-RT RIC). The Non-RT RIC and the Near-RT RIC communicate with each other over an interface defined by O-RAN (specifically, the “A1” interface). The Near-RT RIC and E2 nodes communicate with each other over another interface defined by O-RAN (specifically, the “E2” interface). The E2 nodes are nodes used to implement 5G NR base stations (also referred to as “g Node Bs” or “gNBs”) and/or 4G LTE base stations (also referred to as “e Node Bs”) and “eNBs”).

The present disclosure is directed to providing a broader level control or holistic view to the operator managing the network. The holistic view is provided by implementing the disclosed tracing technique, which traces the communication of the RIC components to provide a greater control to the operator involved in managing and optimizing the network operations. The tracing is performed by capturing the communication between the RIC components and between the RIC components and E2 nodes based on the operator's requirements. The trace data generated based on the tracing is provided to the operator in a file-based format or can be directly streamed in real-time. The detailed working of disclosed tracing techniques will now be explained referring to the figures.

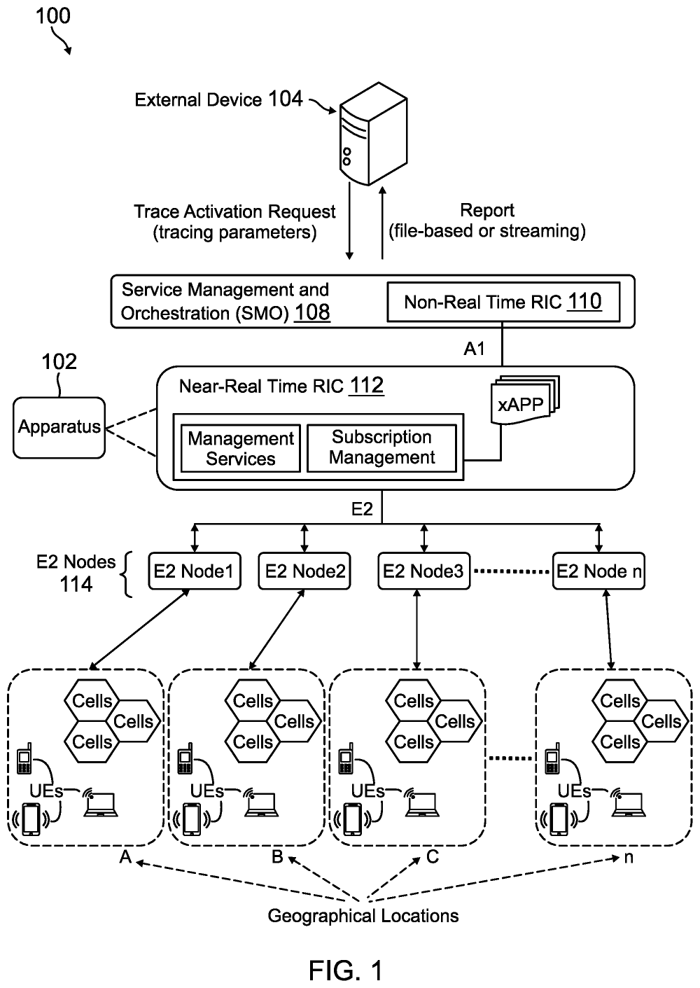

FIG. 1 shows an exemplary environment illustrating tracing of O-RAN operations, in accordance with some embodiments of the present disclosure. The environment 100 comprises an external device 104 connected with a RAN intelligent controller (RIC) 110 or 112. The external device 104 is associated with an entity (also referred as trace collection entity-TCE), which can be an operator managing the network. The device 104 is “external” in the sense that the device 104 is not used to implement a RIC 110 or 112 or an E2 node 114 (described below). The operator may use trace data collected during tracing for different use cases like troubleshooting and validation testing. In the troubleshooting use cases, the operator may solve an existing problem in the network, whereas in the validation testing use cases, the operator may not solve a known problem but merely analyze, fine-tune, or optimize the network. Additionally, the operator may also perform interoperability checks between UEs from different vendors, quality of service (QOS) profile checks for a subscriber after a subscriber complaint, perform checks on a UE which has malfunctioned, checks for radio coverage in a certain area, testing new features, fine-tuning, and optimization of algorithms or procedures.

Along with the above-described use cases, the operator can also use the trace data for service level tracing for IP Multimedia Subsystem (IMS). In the troubleshooting use cases, the operator can use the trace data to solve existing problems with services offered to their subscribers. In validation testing use cases, the operator may not be solving a known problem but performing service regression and automated service testing. At the service level tracing, there may be additional use cases which includes, for example, automated testing of service provider services, regression testing following a network fix, service fault localization within a service provider's network, and service fault localization when a service is hosted by a third-party service provider. The above-described examples of use cases clearly indicate the variety and sensitivity of network operations managed by the operator for providing seamless service to their subscribers. This is where the RICs play a vital role, and therefore, the tracing technique of present disclosure leverages the functionality of the RICs to help the operators better optimize the O-RAN operations, and therefore, provide better services to the subscribers.

The RIC functions comprise a non-real time RIC (Non-RT RIC) 110 and a near-real time RIC (Near-RT RIC) 112. Though this specification, for simplicity and consistency, considers only a single Non-RT RIC 110 and a single Near-RT RIC 112 connected with each other, those of ordinary skill in the art will appreciate that there may be n number of Near-RT RICs which may be connected with a single Non-RT RIC 110. The Non-RT RIC 110 is implemented within the Service Management and Orchestration (SMO) 108 Framework, as defined by the O-RAN Alliance. Typically, the Non-RT RIC 110 performs various “non-real-time” functions like control and optimization of O-RAN components and resources, machine learning (ML) based model training, and policy-based guidance of applications (xApp) running on the Near-RT RIC 112. According to an embodiment, the policies may be operator defined policies to be implemented in the O-RAN.

The Near-RT RIC 112 is a central and critical component of the RIC functions which, at one end, connects with the Non-RT RIC 110 over the A1 interface, and at the other end, connects with E2 nodes 114 over the E2 interface. The Near-RT RIC 112 further hosts functionalities of xApp(s), management services, and the subscription management. The xApp(s), the management services, and the subscription management are provided for performing various operations for example, but not limited to, mobility optimization, Radio Resource Control (RRC) optimization, and key performance indicator (KPI) monitoring. Unlike the Non-RT RIC 110, the Near-RT RIC 112 performs “real-time” control and optimization of O-RAN components and resources.

The E2 nodes 114 are logical nodes that implement base stations, which includes, for example, 4G LTE base stations (also referred to as eNodeBs (eNBs)) and 5G NR base stations (also referred to as Next Generation NodeBs (gNBs)). Examples of E2 nodes include, for example, eNB nodes, O-RAN Central Unit-Control Plane (O-CU-CP) nodes, O-RAN Central Unit-User Plane (O-CU-UP) nodes, and O-RAN Distributed Unit (O-DU) nodes. As shown in FIG. 1, the E2 nodes 114 are used to provide wireless service for one or more cells and the UEs associated with the cells.

Various interfaces, for example the “A1 interface” and the “E2 interface” as shown in FIG. 1, are used for communicating with the Near-RT RIC 112. Those of ordinary skill in the art will appreciate that there could be other interfaces and components (not shown in FIG. 1) which can be implemented for performing various RIC functions. As described above, the Near-RT RIC 112 uses the A1 interface to communicate with the Non-RT RIC 110, and uses the E2 interface to communicate with the E2 nodes 114. The tracing techniques disclosed in present disclosure take advantage of the communications happening with the RIC components over these A1 and E2 interfaces.

The environment 100 further comprises an apparatus 102 implemented at or with the one or more of the RICs 110 or 112 for tracing the O-RAN operations. This specification, for simplicity and consistency, will refer to such apparatus 102 as a server, which typically performs the tracing operation(s) of the present disclosure. Those of ordinary skill in the art will appreciate that the disclosed apparatus 102 can also be implemented in various other computing systems like a computer, a mobile device, or any computing system. According to an embodiment of the present disclosure, the apparatus 102 may be implemented at the Near-RT RIC 112. Those of ordinary skill in the art will also appreciate that the present disclosure is related to O-RAN Alliance Working Group 3 (WG3) and its corresponding specification—“O-RAN.WG3.O1-Interface-for-Near-RT-RIC.” The WG3 focuses on the Near-RT RIC and E2 Interface.

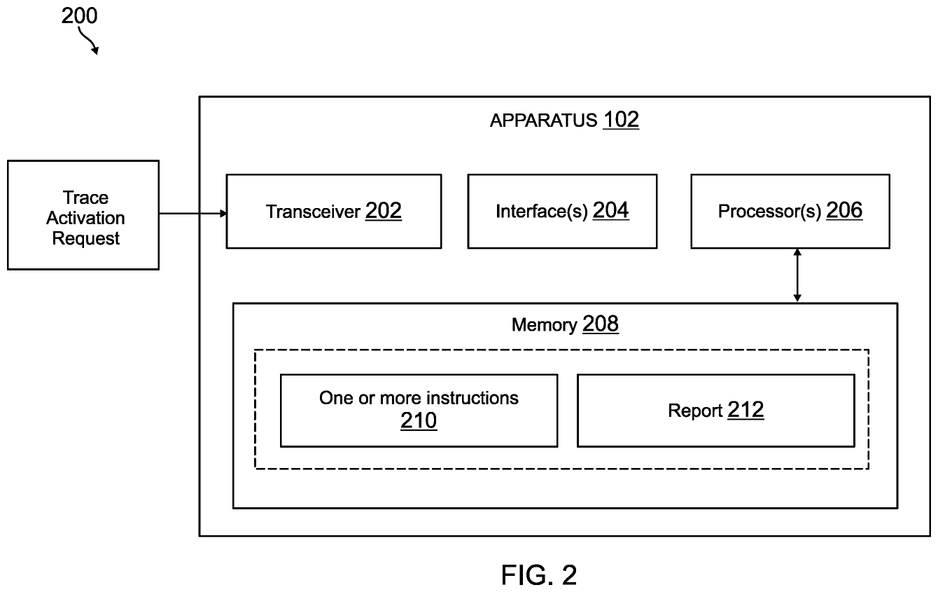

Now, FIG. 1 is explained in conjunction with FIG. 2, which is a detailed block diagram 200 of the apparatus 102 for tracing the O-RAN operations, in accordance with some embodiments of the present disclosure. According to an embodiment of the present disclosure, the apparatus 102 may comprise at least one transceiver 202, at least one interface 204, at least one processor 206, and at least one memory 208. The at least one transceiver 202 may collectively represent a transmitter and receiver. The at least one transceiver 202 may be configured to transmit and receive data/information to/from the Non-RT RIC 110 and the external device 104 at one end, and the E2 nodes 114 at another end. In one non-limiting embodiment, the at least one processor 206 may be communicatively coupled with transceiver 202 for receiving and transmitting such data and/or information.

The at least one interface 204 may include a variety of software and hardware interfaces, for example, a web interface, a graphical user interface, an input device-output device (I/O) interface, a network interface, and the like. The I/O interfaces may allow the apparatus 102 to communicate with other devices. The network interface may allow the apparatus 102 to interact with one or more networks either directly or via any other network.

The at least one processor 206 may include, but is not limited to, microprocessors, microcomputers, micro-controllers, central processing units, state machines, logic circuitries, and/or any devices that manipulate signals based on operational instructions. A processor may also be implemented as a combination of computing devices, for example, a combination of a plurality of microprocessors or any other such configuration.

The at least one memory 208 may be communicatively coupled to the at least one processor 206. The memory 208 may comprise one or more instructions 210. The memory 208 may also store a report (temporarily) generated based on the tracing. The memory 208 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud, and so forth. In an embodiment, the at least one processor 206 may be capable of executing the one or more instructions 210 stored in the memory 208 for performing various operations of the apparatus 102.

Now referring back to FIG. 1, it can be seen that the apparatus 102 is implemented at the Near-RT RIC 112. As the Near-RT RIC 112 connects with both the Non-RT RIC 110 and E2 nodes 114 over the A1 and E2 interfaces respectively, it plays a vital role in tracing the O-RAN operations. Initially, the at least one processor 206 receives a trace activation request from the external device 104 associated with an entity (for example, an operator) intended to trace the O-RAN) operations. According to another embodiment, the transceiver 202 receives the trace activation request and then forwards it to the processor 206 for further processing. According to yet another embodiment, the trace activation request may be first received at the SMO 108 and then it is transmitted to the transceiver 202/processor 206 of the apparatus 102 implemented at the Near-RT RIC 112.

The trace activation request comes along with tracing parameters, which include, for example, a RIC ID, an E2 Node ID, a Near-RT RIC Trace ID, a Trace Depth, a list of Near-RT RIC interfaces, and an IP address of the external device (external device 104 in this case). The RIC ID comprises a unique identifier of the RIC (RIC 112 in this case) controlling the O-RAN operations. The E2 Node ID comprises a list of unique identifiers of E2 nodes 114 (E2 Node1, E2 Node2, E2 Node3, E2 Node n in this case) associated with the RIC 112. The Near-RT RIC Trace ID comprises a unique identifier of the Near-RT RIC (Near-RT RIC 112 in this case). The Trace Depth comprises a set of trace levels indicating a degree of information to be traced while tracing the O-RAN operations. According to an embodiment, the set of trace levels comprises a minimum trace, a medium trace, and a maximum trace. The list of Near-RT RIC interfaces comprises a list of interfaces (A1 and E2 in this case) over which the plurality of RIC components communicates. The above-described tracing parameters are the operator specific requirements for tracing the O-RAN operations.

The at least one processor 206 initiates the tracing of the O-RAN operations based on the tracing parameters received along with the trace activation request. Here, the tracing comprises keeping capturing the communication between the RIC components (Non-RT RIC 110 and Near-RT RIC 112) and between the RIC components and the E2 nodes 114 controlling the O-RAN operations over the plurality of interfaces (A1 and E2). The tracing is not limited to the RIC components, and however it extends till the UE level connected with the cells. In other words, the tracing further includes capturing communication between the E2 nodes 114 and the plurality of UE associated with the cells of different geographical locations A, B, C, and n as shown in FIG. 1. This also helps in easily identifying geographical area problems, thus narrowing down the problems and efficiently rectifying them. The aim is to capture all the events happening over the network which are exposed to the RIC components, specially the Near-RT RIC 112 and E2 nodes 114 to provide a better view about the functioning of the network to the operators.

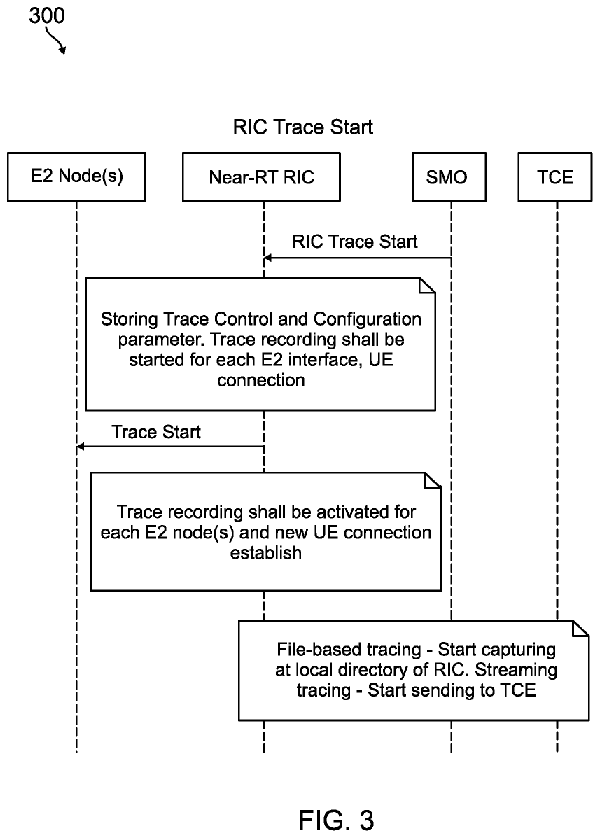

FIGS. 3-7 shows different examples of the tracing operations performed according to various embodiments of the present disclosure. As shown in FIG. 3, a trace “start” request (for example, trace activation request) is initiated from the SMO 108. As described earlier, the trace activation request is received from the external device 104 associated with the entity (also referred as Trace Collection Entity—TCE) along with tracing parameters (also referred as trace control and configuration parameter in FIG. 3). Upon receiving the trace activation request, the apparatus 102 (implemented at the Near-RT RIC 112) starts recording/capturing the communication over the E2 interface. As the tracing progresses during the trace session based on the trace activation message, the at least one processor 206 keeps capturing the messages/communication and generates a report 212 which comprises trace data based on selected format (for example, file-based or streaming based). The trace data of the report 212 includes all the details pertaining to the messages/communication between the UE, E2 nodes 114, and Near-RT RIC 112. According to an embodiment, the report 212 may be temporarily stored in the memory 208 or RIC's local directory, and then it is transmitted to the external device 104 of the entity. The report 212 may be transmitted by the transceiver 202 or the processor 206. According to an embodiment, the trace data of the report 212 may be streamed in a format as shown below.

Streaming trace data

| Header | | Payload | |
|---|---|---|---|
| Common fields | VS Extension | Payload size | Payload data |

It can be observed that the report may be divided into two parts—“Header” and “Payload.” The Header comprises further two information categories, for example, common fields and VS extension. The common fields comprise information pertaining to a timestamp and the types of messages which are captured over the interfaces (A1 and E2) during the tracing. The VS extension is a vendor-specific extension to which the trace date may be streamed. The Payload further comprises two categories, for example, payload size and payload data. The payload data will comprise the actual trace data for example, but not limited to, messages pertaining to E2 subscription request, E2 subscription response, handover request, and handover response. The payload size will comprise the size (in bytes for example) of the payload data. Those of ordinary skill in the art will appreciate that the above-described report format is merely an example, and there may be other formats for streaming the report to the external device 104.

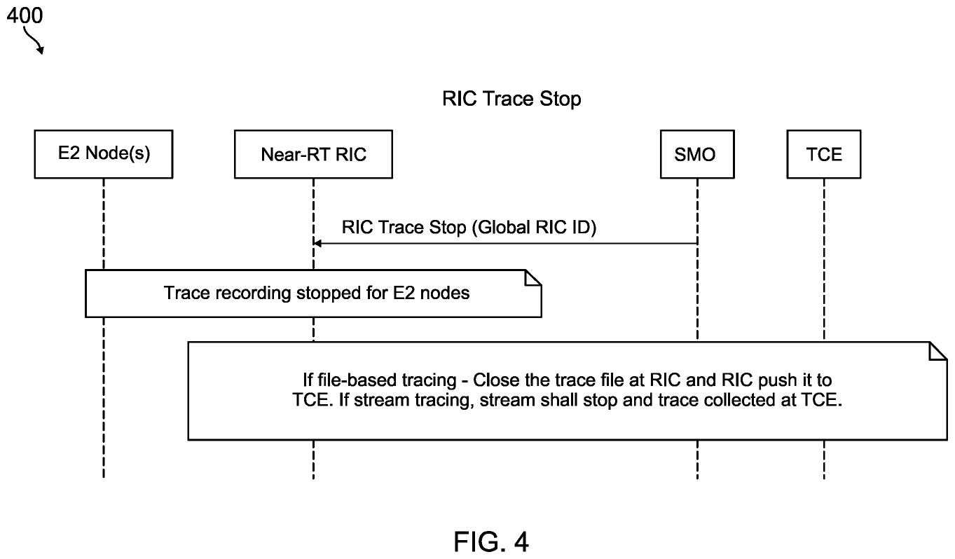

Now referring to FIG. 4, which illustrates trace “stop” operation in accordance with some embodiments of the present disclosure. Similar to trace initiate request, the trace stop request is also initiated from the external device 104 associated with an entity (also referred as Trace Collection Entity—TCE) along with RIC ID. As described above, the RIC ID is the unique identifier of the RIC (RIC 112 in this case) whose components are tracing the O-RAN operations. Further, the trace stop request is then further forwarded by the SMO 108 to the Near-RT RIC 112. Upon receipt of such a stop request, the apparatus 102 (implemented at the Near-RT RIC 112) stops recording/capturing the communication over the E2 interface(s) and generates the report 212 in the prescribed format, file-based or streaming. The report generating procedure and format is explained above, and therefore, it is not repeated here for the sake of brevity.

### Trace Operation at E2 Interface

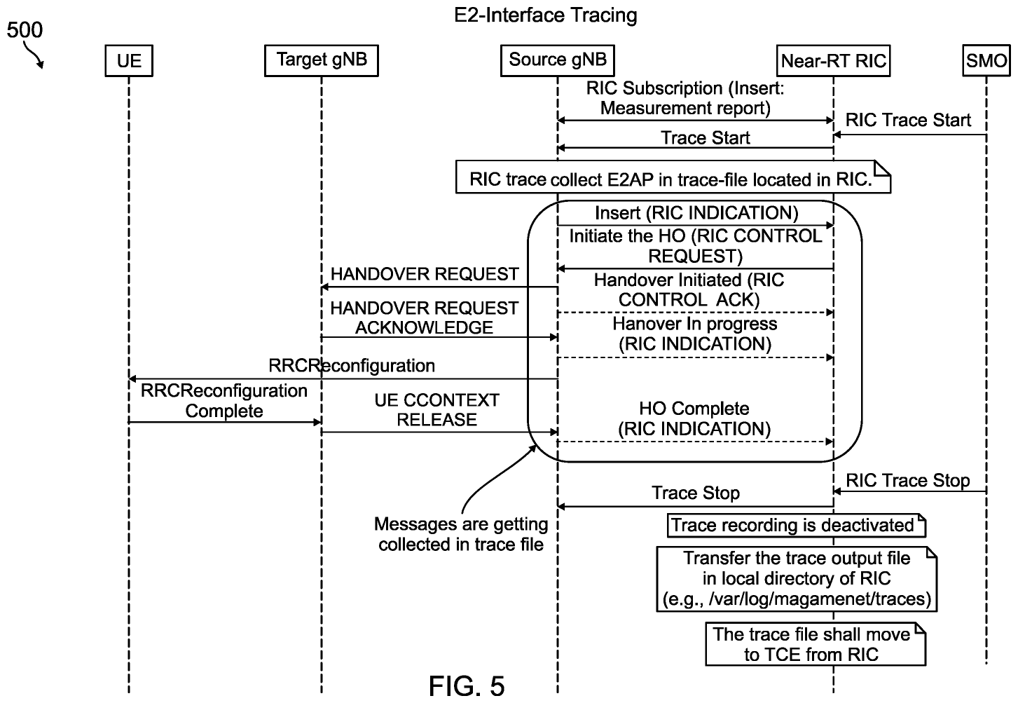

In FIG. 5, a detailed overview of the E2 interface tracing is shown in detail. It can be observed that along with the SMO 108, Near-RT RIC 112, and the UE, two additional E2 nodes, for example, source gNB and target gNB, are also shown in the FIG. 5. Those of ordinary skill in the art will understand that the source gNB and target gNB are the E2 nodes 114. The messages which are collected/captured during the trace session at the E2 interface are shown inside the rectangular block. Unlike FIGS. 3 and 4, the information provided in FIG. 5 is at a detailed level. That means, the actual messages which are being communicated with the RIC components are captured in the report. FIG. 5 also shows the aspect of deactivating/stopping the trace activation request, which is already explained above referring to FIG. 4.

### Trace Operation at A1 Interface

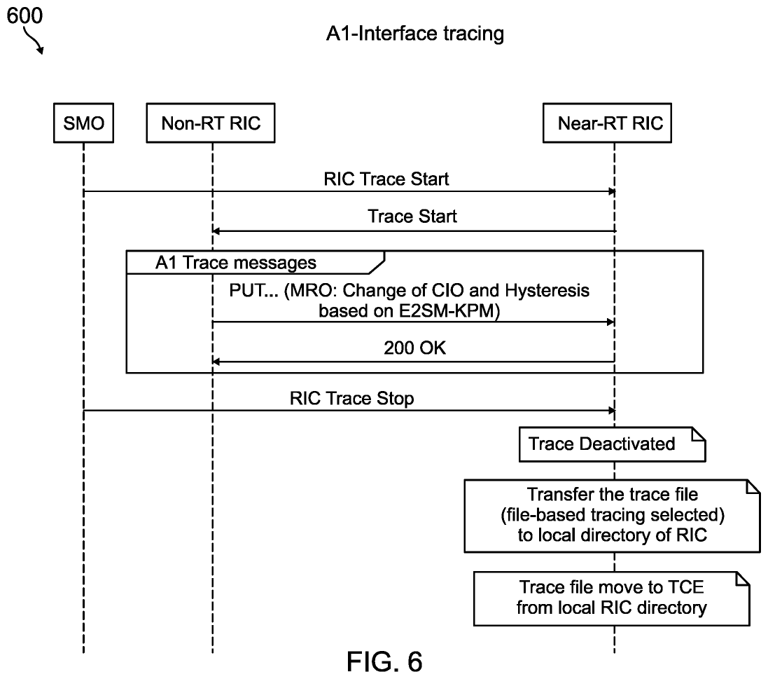

In FIG. 6, a detailed overview of the A1 interface tracing is shown in detail. As can be seen from FIG. 6, the Near-RT RIC 112 receives the trace activation request from the SMO 108 via the Non-RT RIC 110. Upon receipt of the activation request, the apparatus 102 (implemented at the Near-RT RIC 112) starts capturing the messages over the A1 interface. The messages captured over the A1 interface are shown in the rectangular block under the heading “A1 trace messages.” That is, the message related to change of Cell Individual Offset (CIO) and hysteresis based on E2SM-KPM (from Non-RT RIC to Near-RT RIC) and the acknowledgment message (from Near-RT RIC to Non-RT RIC) is captured over the A1 interface. FIG. 6 also shows the aspect of deactivating/stopping the trace activation request, which is already explained above referring to FIG. 4.

### Trace Operation at A1 and E2 Interfaces

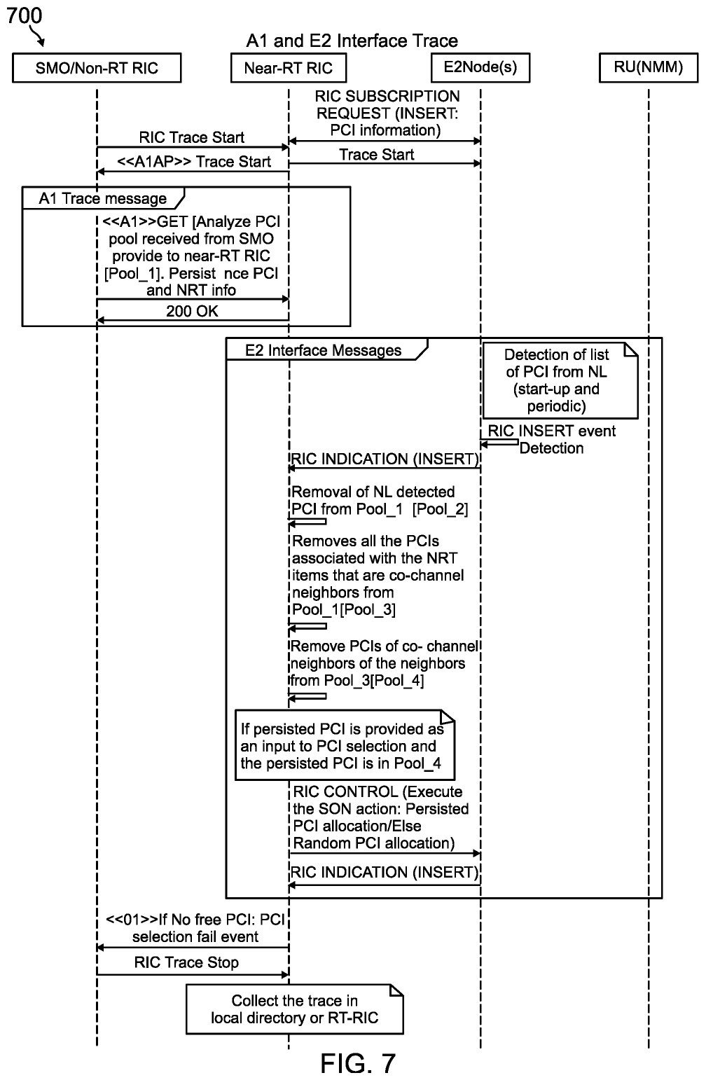

FIG. 7 shows a consolidated or combined view of the trace operations performed at both A1 and E2 interfaces. As can be seen from FIG. 7, the Near-RT RIC 112 receives the trace activation request from the SMO 108 via the Non-RT RIC 110. Upon receipt of the activation request, the apparatus 102 (implemented at the Near-RT RIC 112) starts capturing the messages over the A1 interface. The messages captured over the A1 interface are shown in the first rectangular block under the heading “A1 trace messages.” The messages captured include instructions to analyze Physical Cell Identity (PCI) pool (Pool_1) and the acknowledgment message. Based on the activation request, the Near-RT RIC 112 starts the PCI detection operation. The messages captured while performing such operation are also captured at the E2 interface as shown in the second rectangular block under the heading “E2 Interface Messages.” Finally, the trace deactivating/stopping request is received from the SMO 108. Based on the deactivation request, the apparatus 102 (implemented at the Near-RT RIC 112) generates a report and shares it with the external device 104.

From the above discussed examples of FIGS. 3-7, it can be observed that the different levels of information are captured during the tracing. However, the tracing technique of the present disclosure provides various options to the operator for providing the trace data to the operators. Referring back to tracing parameter “Trace Depth” comprises the set of trace levels—a minimum trace, a medium trace, and a maximum trace for generating the report. The minimum, medium, and maximum trace report can be implemented for the E2AP trace content and the A1AP trace content as shown in tables 1 and 2.

TABLE 1
E2AP trace record content

| Interface | | Level of details | | | |
|---|---|---|---|---|---|
| (specific | | (Trace Depth) | | | |
| messages) | Format | Min | Med | Max | Description |
| E2 | Decoded | M | M | O | Message name |
| | | O | O | O | Record extensions |
| | | M | M | X | ID of traced E2node |
| | | | | | RIC ID of connected RIC |
| | | O | O | X | IE extracted from |
| | | | | | E2AP messages |
| | | | | | between the traced |
| | | | | | Near-RT RIC and the |
| | | | | | E2node as per <<E2AP |
| | | | | | specification ref>> |
| | ASN.1 | X | X | M | Raw E2 Messages: |
| | | | | | E2AP messages |
| | | | | | between the traced |
| | | | | | Near-RT RIC and the |
| | | | | | E2node. The encoded |
| | | | | | content of the |
| | | | | | message is provided. |

TABLE 2
A1AP trace record content

| Interface | | Level of details | | | |
|---|---|---|---|---|---|
| (specific | | (Trace Depth) | | | |
| messages) | Format | Min | Med | Max | Description |
| A1 | Decoded | M | M | O | Message name |
| | | O | O | O | Record extensions |
| | | M | M | X | xApp ID of traced |
| | | | | | Near-RT RIC |
| | | | | | non-RT RIC ID of |
| | | | | | connected non-RT RIC |
| | | O | O | X | IE extracted from A1AP |
| | | | | | messages between |
| | | | | | the traced Non-RT RIC |
| | | | | | and the Near-RT |
| | | | | | RIC as per <<A1AP |
| | | | | | specification ref>> |
| | Encoded* | X | X | M | Raw A1 Messages: A1AP |
| | | | | | messages between |
| | | | | | the traced Non-RT RIC |
| | | | | | and the Near-RT |
| | | | | | RIC. The encoded content |
| | | | | | of the message is |
| | | | | | provided. |

Referring to the above Tables 1 and 2, the symbol “M” is mandatory, “O” is optional, and “X” is “Not applicable.” The symbol “M” indicates that the field must be in the trace record if it is available, for example, if the message appears during the trace recording session and the Information Element (IE) is present in the message. The symbol “O” indicates that the field is optional, and its support is a matter of agreement between equipment manufacturer and network operator. Further, the symbol “X” indicates that the field is not required in this instance.

Considering the above Table 1, E2AP messages can be captured or streamed in decoded or encoded format depending on the trace depth level (minimum, medium, maximum) chosen during trace activation or provided according to the tracing parameters. If the depth level “Minimum” and “Medium” is chosen, then the report will have messages, Information Elements, and IDs of entities traced in decoded format. The size of the trace file will be small. Hence, to keep the size small, most of the places in the decoded format use “M” or “O” in Minimum and Medium depth levels. Whereas, if the depth level “Maximum” is chosen, the report will contain all information carried in messages that may increase the size of a file. Hence, all the information is collected in an encoded format (for example, ASN.1 encoded).

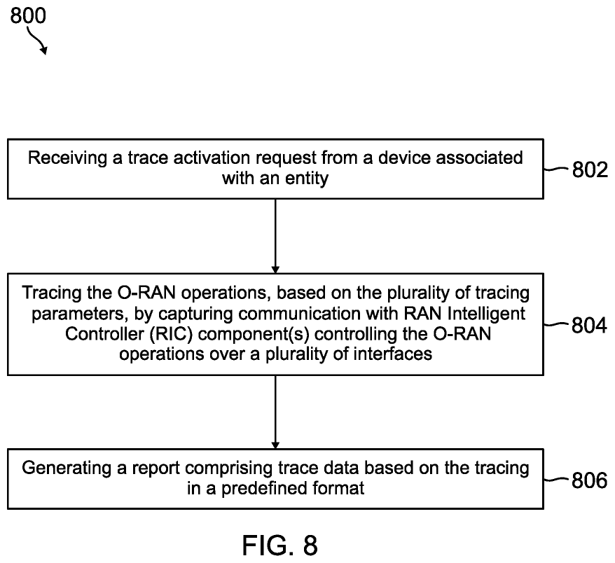

Referring now to FIG. 8, a flowchart is described illustrating an exemplary method 800 for tracing O-RAN operations, according to an embodiment of the present disclosure. The method 800 is merely provided for exemplary purposes, and embodiments are intended to include or otherwise cover any methods or procedures for tracing O-RAN operations.

The method 800 may include, at block 802, receiving a trace activation request from a device associated with an entity intended to trace open radio access network (O-RAN) operations. The trace activation request comprises a plurality of tracing parameters. For example, the at least one transceiver 202 or the at least one processor 206 of FIG. 2 may be configured to receive the trace activation request from the device.

At block 804, the method 800 includes tracing the O-RAN operations, based on the plurality of tracing parameters, by capturing communication with at least one or more of a plurality of RAN Intelligent Controller (RIC) components controlling the O-RAN operations over a plurality of interfaces. For example, the at least one processor 206 of FIG. 2 may be configured to trace the O-RAN operations by capturing the communication with the Near-RT RIC 112.

At block 806, the method 800 includes generating a report comprising trace data based on the tracing in a predefined format. For example, the at least one processor 206 of FIG. 2 may be configured to generate the report comprising the trace data based on the tracing in the predefined format.

The above method 800 may be described in the general context of computer executable instructions. Generally, computer executable instructions can include routines, programs, objects, components, data structures, procedures, modules, and functions, which perform specific functions or implement specific abstract data types.

The order in which the various operations of the method 800 are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s). Generally, where there are operations illustrated in the Figures, those operations may have corresponding counterpart means-plus-function components.

It may be noted here that the subject matter of some or all embodiments described with reference to FIGS. 1-7 may be relevant for the methods and the same is not repeated for the sake of brevity.

In a non-limiting embodiment of the present disclosure, one or more non-transitory computer-readable media may be utilized for implementing the embodiments consistent with the present disclosure. A computer-readable media refers to any type of physical memory (such as the memory 208) on which information or data readable by a processor may be stored. Thus, a computer-readable media may store one or more instructions for execution by the at least one processor 206, including instructions for causing the at least one processor 206 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The various illustrative logical blocks, modules, and operations described in connection with the present disclosure may be implemented or performed with a general-purpose processor, discrete gate or transistor logic, discrete hardware components or any combination thereof designed to perform the functions described herein. A general-purpose processor may include a microprocessor, but in the alternative, the processor may include any commercially available processor, controller, microcontroller, or state machine. A processor may also be implemented as a combination of computing devices, e.g., a plurality of microprocessors, or any other such configuration.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

The terms “an embodiment”, “embodiment”, “embodiments”, “the embodiment”, “the embodiments”, “one or more embodiments”, “some embodiments”, and “one embodiment”, “other embodiment”, “yet another embodiment”, “non-limiting embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

A description of an embodiment with several components in communication with each other does not imply that all such components are required. On the contrary, a variety of optional components are described to illustrate the wide variety of possible embodiments of the disclosed methods and systems.

### EXAMPLE EMBODIMENTS

Example 1 includes a method comprising: tracing the open radio access network (O-RAN) operations, based on a plurality of tracing parameters, by capturing communication with at least one of a plurality of RAN Intelligent Controller (RIC) components controlling the O-RAN operations over a plurality of interfaces; and generating a report comprising trace data based on the tracing in a predefined format.

Example 2 includes the method of Example 1, wherein the predefined format comprises a file-based format or a streaming format.

Example 3 includes the method of any of Examples 1-2, further comprising: receiving a trace activation request from a device associated with an entity intended to trace O-RAN operations, wherein the trace activation request comprises the plurality of tracing parameters; and transmitting the report to the device associated with the entity, wherein the entity comprises an operator providing services to subscribers.

Example 4 includes the method of any of Examples 1-3, wherein the plurality of RIC components comprises a non-real time RIC (Non-RT RIC) and a near-real time RIC (Near-RT RIC); wherein the communication with the at least one of the plurality of RIC components comprises a communication between the at least one of the plurality of RIC components and an E2 node, wherein the E2 node is used to implement a base station to provide wireless service to a plurality of user equipment using a cell; and wherein the plurality of interfaces comprises A1 interface and E2 interface, wherein the A1 interface facilitates communication between the Non-RT RIC and the Near-RT RIC, and wherein the E2 interface facilitates communication between the Near-RT RIC and the E2 node.

Example 5 includes the method of Example 4, wherein the E2 node comprises at least one of an eNodeB (eNB), an O-RAN Central Unit-Control Plane (O-CU-CP), an O-RAN Central Unit-User Plane (O-CU-UP), an O-RAN Distributed Unit (O-DU), and a Next Generation NodeB (gNB).

Example 6 includes the method of any of Examples 4-5, wherein tracing the O-RAN operations further comprises capturing communication between the E2 node and at least one of the plurality of user equipment.

Example 7 includes the method of any of Examples 1-6, wherein the plurality of tracing parameters comprises at least one of: a RIC ID comprising a unique identifier of a RIC controlling the O-RAN operations; an E2 Node ID comprising a unique identifier of an E2 node associated with the RIC; a Near-RT RIC Trace ID comprising a unique identifier of a Near-RT RIC associated with the RIC; a Trace Depth comprising a set of trace levels indicating a degree of information to be traced while tracing the O-RAN operations, wherein the set of trace levels comprises a minimum trace, a medium trace, and a maximum trace; a list of Near-RT RIC interfaces comprising a list of interfaces over which the at least one of the plurality of RIC components communicates; and an IP address of the device.

Example 8 includes an apparatus comprising: a memory; and at least one transceiver; and at least one processor communicatively coupled with the memory and the at least one transceiver, wherein the at least one processor is configured to: trace open radio access network (O-RAN) operations, based on a plurality of tracing parameters, by capturing communication with at least one of a plurality of RAN Intelligent Controller (RIC) components controlling the O-RAN operations over a plurality of interfaces; and generate a report comprising trace data based on the tracing in a predefined format.

Example 9 includes the apparatus of Example 8, wherein the predefined format comprises a file-based format or a streaming format.

Example 10 includes the apparatus of any of Examples 8-9, wherein the at least one processor is further configured to: receive a trace activation request from a device associated with an entity intended to trace O-RAN operations, wherein the trace activation request comprises the plurality of tracing parameters; and transmit the report to the device associated with the entity, wherein the entity comprises an operator providing services to subscribers.

Example 11 includes the apparatus of any of Examples 8-10, wherein the plurality of RIC components comprises a non-real time RIC (Non-RT RIC) and a near-real time RIC (Near-RT RIC); wherein the communication with the at least one of the plurality of RIC components comprises a communication between the at least one of the plurality of RIC components and an E2 node, wherein the E2 node is used to implement a base station to provide wireless service to a plurality of user equipment using at least one cell; and wherein the plurality of interfaces comprises A1 interface and E2 interface, wherein the A1 interface facilitates communication between the Non-RT RIC and the Near-RT RIC, and wherein the E2 interface facilitates communication between the Near-RT RIC and the E2 node.

Example 12 includes the apparatus of Example 11, wherein the E2 node comprises at least one of an eNodeB (eNB), an O-RAN Central Unit-Control Plane (O-CU-CP), an O-RAN Central Unit-User Plane (O-CU-UP), an O-RAN Distributed Unit (O-DU), and a Next Generation NodeB (gNB).

Example 13 includes the apparatus of any of Examples 11-12, wherein the at least one processor is further configured to trace the O-RAN operations by capturing communication between the E2 node and at least one of the plurality of user equipment.

Example 14 includes the apparatus of any of Examples 8-13, wherein the plurality of tracing parameters comprises at least one of: a RIC ID comprising a unique identifier of a RIC controlling the O-RAN operations; an E2 Node ID comprising a list of unique identifiers of an E2 node associated with the RIC; a Near-RT RIC Trace ID comprising a unique identifier of a Near-RT RIC associated with the RIC; a Trace Depth comprising a set of trace levels indicating a degree of information to be traced while tracing the O-RAN operations, wherein the set of trace levels comprises a minimum trace, a medium trace, and a maximum trace; a list of Near-RT RIC interfaces comprising a list of interfaces over which the at least one of the plurality of RIC components communicates; and an IP address of the device.

Example 15 includes a non-transitory computer readable media storing one or more instructions executable by at least one processor, the one or more instructions comprising: one or more instructions for tracing open radio access network (O-RAN) operations, based on a plurality of tracing parameters, by capturing communication with at least one of a plurality of RAN Intelligent Controller (RIC) components controlling the O-RAN operations over a plurality of interfaces; and one or more instructions for generating a report comprising trace data based on the tracing in a predefined format.

Example 16 includes the non-transitory computer readable media of Example 15, wherein the predefined format comprises a file-based format or a streaming format.

Example 17 includes the non-transitory computer readable media of any of Examples 15-16, wherein the one or more instructions further comprise: one or more instructions for receiving a trace activation request from a device associated with an entity intended to trace O-RAN operations, wherein the trace activation request comprises the plurality of tracing parameters; and one or more instructions for transmitting the report to the device associated with the entity, wherein the entity comprises an operator providing services to subscribers.

Example 18 includes the non-transitory computer readable media of any of Examples 15-17, wherein the plurality of RIC components comprises a non-real time RIC (Non-RT RIC) and a near-real time RIC (Near-RT RIC); wherein the communication with the at least one of the plurality of RIC components comprises a communication between the at least one of the plurality of RIC components and an E2 node, wherein the E2 node is used to implement a base station to provide wireless service to a plurality of user equipment using a cell; wherein the E2 node comprises at least one of an eNodeB (eNB), an O-RAN Central Unit-Control Plane (O-CU-CP), an O-RAN Central Unit-User Plane (O-CU-UP), an O-RAN Distributed Unit (O-DU), and a Next Generation NodeB (gNB); and wherein the plurality of interfaces comprises A1 interface and E2 interface, wherein the A1 interface facilitates communication between the Non-RT RIC and the Near-RT RIC, and wherein the E2 interface facilitates communication between the Near-RT RIC and the E2 node.

Example 19 includes the non-transitory computer readable media of Example 18, wherein tracing the O-RAN operations further comprises capturing communication between the E2 node and at least one of the plurality of user equipment.

Example 20 includes the non-transitory computer readable media of any of Examples 15-19, wherein the plurality of tracing parameters comprises at least one of: a RIC ID comprising a unique identifier of a RIC controlling the O-RAN operations; an E2 Node ID comprising a unique identifier of an E2 node associated with the RIC; a Near-RT RIC Trace ID comprising a unique identifier of a Near-RT RIC associated with the RIC; a Trace Depth comprising a set of trace levels indicating a degree of information to be traced while tracing the O-RAN operations, wherein the set of trace levels comprises a minimum trace, a medium trace, and a maximum trace; a list of Near-RT RIC interfaces comprising a list of interfaces over which the plurality of RIC component communicates; and an IP address of the device.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method comprising:
tracing open radio access network (O-RAN) operations, based on a plurality of tracing parameters, by capturing communication with at least one of a plurality of RAN Intelligent Controller (RIC) components controlling the O-RAN operations over a plurality of interfaces; and
generating a report comprising trace data based on the tracing in a predefined format.

2. The method of claim 1, wherein the predefined format comprises a file-based format or a streaming format.

3. The method of claim 1, further comprising:
receiving a trace activation request from a device associated with an entity intended to trace O-RAN operations, wherein the trace activation request comprises the plurality of tracing parameters; and
transmitting the report to the device associated with the entity, wherein the entity comprises an operator providing services to subscribers.

4. The method of claim 1, wherein the plurality of RIC components comprises a non-real time RIC (Non-RT RIC) and a near-real time RIC (Near-RT RIC);
wherein the communication with the at least one of the plurality of RIC components comprises a communication between the at least one of the plurality of RIC components and an E2 node, wherein the E2 node is used to implement a base station to provide wireless service to a plurality of user equipment using a cell; and
wherein the plurality of interfaces comprises A1 interface and E2 interface, wherein the A1 interface facilitates communication between the Non-RT RIC and the Near-RT RIC, and wherein the E2 interface facilitates communication between the Near-RT RIC and the E2 node.

5. The method of claim 4, wherein the E2 node comprises at least one of an eNodeB (eNB), an O-RAN Central Unit-Control Plane (O-CU-CP), an O-RAN Central Unit-User Plane (O-CU-UP), an O-RAN Distributed Unit (O-DU), and a Next Generation NodeB (gNB).

6. The method of claim 4, wherein tracing the O-RAN operations further comprises capturing communication between the E2 node and at least one of the plurality of user equipment.

7. The method of claim 1, wherein the plurality of tracing parameters comprises at least one of:
a RIC ID comprising a unique identifier of a RIC controlling the O-RAN operations;
an E2 Node ID comprising a unique identifier of an E2 node associated with the RIC;
a Near-RT RIC Trace ID comprising a unique identifier of a Near-RT RIC associated with the RIC;
a Trace Depth comprising a set of trace levels indicating a degree of information to be traced while tracing the O-RAN operations, wherein the set of trace levels comprises a minimum trace, a medium trace, and a maximum trace;
a list of Near-RT RIC interfaces comprising a list of interfaces over which the at least one of the plurality of RIC components communicates; and
an IP address of a device.

8. An apparatus comprising:
a memory;
at least one transceiver; and
at least one processor communicatively coupled with the memory and the at least one transceiver, wherein the at least one processor is configured to:
trace open radio access network (O-RAN) operations, based on a plurality of tracing parameters, by capturing communication with at least one of a plurality of RAN Intelligent Controller (RIC) components controlling the O-RAN operations over a plurality of interfaces; and
generate a report comprising trace data based on the tracing in a predefined format.

9. The apparatus of claim 8, wherein the predefined format comprises a file-based format or a streaming format.

10. The apparatus of claim 8, wherein the at least one processor is further configured to:
receive a trace activation request from a device associated with an entity intended to trace O-RAN operations, wherein the trace activation request comprises the plurality of tracing parameters; and
transmit the report to the device associated with the entity, wherein the entity comprises an operator providing services to subscribers.

11. The apparatus of claim 8, wherein the plurality of RIC components comprises a non-real time RIC (Non-RT RIC) and a near-real time RIC (Near-RT RIC);
wherein the communication with the at least one of the plurality of RIC components comprises a communication between the at least one of the plurality of RIC components and an E2 node, wherein the E2 node is used to implement a base station to provide wireless service to a plurality of user equipment using at least one cell; and
wherein the plurality of interfaces comprises A1 interface and E2 interface, wherein the A1 interface facilitates communication between the Non-RT RIC and the Near-RT RIC, and wherein the E2 interface facilitates communication between the Near-RT RIC and the E2 node.

12. The apparatus of claim 11, wherein the E2 node comprises at least one of an eNodeB (eNB), an O-RAN Central Unit-Control Plane (O-CU-CP), an O-RAN Central Unit-User Plane (O-CU-UP), an O-RAN Distributed Unit (O-DU), and a Next Generation NodeB (gNB).

13. The apparatus of claim 11, wherein the at least one processor is further configured to trace the O-RAN operations by capturing communication between the E2 node and at least one of the plurality of user equipment.

14. The apparatus of claim 8, wherein the plurality of tracing parameters comprises at least one of:
a RIC ID comprising a unique identifier of a RIC controlling the O-RAN operations;
an E2 Node ID comprising a list of unique identifiers of an E2 node associated with the RIC;
a Near-RT RIC Trace ID comprising a unique identifier of a Near-RT RIC associated with the RIC;
a Trace Depth comprising a set of trace levels indicating a degree of information to be traced while tracing the O-RAN operations, wherein the set of trace levels comprises a minimum trace, a medium trace, and a maximum trace;
a list of Near-RT RIC interfaces comprising a list of interfaces over which the at least one of the plurality of RIC components communicates; and
an IP address of a device.

15. A non-transitory computer readable media storing one or more instructions executable by at least one processor, the one or more instructions comprising:
one or more instructions for tracing open radio access network (O-RAN) operations, based on a plurality of tracing parameters, by capturing communication with at least one of a plurality of RAN Intelligent Controller (RIC) components controlling the O-RAN operations over a plurality of interfaces; and
one or more instructions for generating a report comprising trace data based on the tracing in a predefined format.

16. The non-transitory computer readable media of claim 15, wherein the predefined format comprises a file-based format or a streaming format.

17. The non-transitory computer readable media of claim 15, wherein the one or more instructions further comprise:
one or more instructions for receiving a trace activation request from a device associated with an entity intended to trace O-RAN operations, wherein the trace activation request comprises the plurality of tracing parameters; and
one or more instructions for transmitting the report to the device associated with the entity, wherein the entity comprises an operator providing services to subscribers.

18. The non-transitory computer readable media of claim 15, wherein the plurality of RIC components comprises a non-real time RIC (Non-RT RIC) and a near-real time RIC (Near-RT RIC);
wherein the communication with the at least one of the plurality of RIC components comprises a communication between the at least one of the plurality of RIC components and an E2 node, wherein the E2 node is used to implement a base station to provide wireless service to a plurality of user equipment using a cell;
wherein the E2 node comprises at least one of an eNodeB (eNB), an O-RAN Central Unit-Control Plane (O-CU-CP), an O-RAN Central Unit-User Plane (O-CU-UP), an O-RAN Distributed Unit (O-DU), and a Next Generation NodeB (gNB); and
wherein the plurality of interfaces comprises A1 interface and E2 interface, wherein the A1 interface facilitates communication between the Non-RT RIC and the Near-RT RIC, and wherein the E2 interface facilitates communication between the Near-RT RIC and the E2 node.

19. The non-transitory computer readable media of claim 18, wherein tracing the O-RAN operations further comprises capturing communication between the E2 node and at least one of the plurality of user equipment.

20. The non-transitory computer readable media of claim 15, wherein the plurality of tracing parameters comprises at least one of:
a RIC ID comprising a unique identifier of a RIC controlling the O-RAN operations;
an E2 Node ID comprising a unique identifier of an E2 node associated with the RIC;
a Near-RT RIC Trace ID comprising a unique identifier of a Near-RT RIC associated with the RIC;
a Trace Depth comprising a set of trace levels indicating a degree of information to be traced while tracing the O-RAN operations, wherein the set of trace levels comprises a minimum trace, a medium trace, and a maximum trace;
a list of Near-RT RIC interfaces comprising a list of interfaces over which the plurality of RIC component communicates; and
an IP address of a device.
